(19) United States
(12) Patent Application Publication
(10) Pub. No.: US 2006/0019527 A1
(43) Pub. Date: Jan. 26, 2006

(54) Adjustable audio cable vibration reducing device

(76) Inventor: Shu-Sheng Chen, Taipei (TW)

Correspondence Address: Shu-Sheng Chen, No. 11, Lane 45, Yu-Ying St. Chingmei, Taipei, 11671, TW

(21) Appl. No.: 11/186,947

(22) Filed: Jul. 22, 2005

(30) Foreign Application Priority Data
Jul. 26, 2004 (TW) 093211774

(51) Int. Cl. H01R 13/648

(52) U.S. Cl. 439/382

(57) ABSTRACT

An adjustable audio cable vibration reducing device for minimizing cable vibration. The device has two porous vertical pieces and at least one horizontal supporting piece. The length of the porous vertical pieces can be selected appropriately, as can the height of the horizontal supporting pieces. Multiple horizontal supporting pieces can be utilized to support several cables simultaneously. Sound can be tuned by changing the material of the horizontal supporting pieces or porous vertical pieces. Vibration can be transformed into heat energy by filling energy-transforming holes with a suitable material, such as rubber or foam.

### BACKGROUND OF THE INVENTION

1. The Field of the Invention

The present invention is an audio cable support and vibration reducing device. This device comprises two porous vertical pieces and at least one horizontal supporting piece. The present invention can not only increase the total length of cable supporting and vibration reducing by adjusting the height of horizontal supporting pieces and using the apposite length of porous vertical pieces, but also reduce the consumer's cost by using multiple horizontal supporting pieces simultaneously to support cables. The consumer can tune the sound by changing the material of the horizontal supporting pieces or porous vertical pieces.

2. Description of the Prior Art

In the current high end audio industry, it is desirable to have audio equipment that can produce more transparent sound, finer details, deeper and wider sound range with more extended high, more full-body mid, and more solid bass. To reach these goals, it is crucial to reduce all kinds of un-invited and undesirable vibration. Existing technologies have emphasized the reduction of the vibration from the base of audio equipment, but not vibration transferred from audio equipment through the connecting metal-based cables. Such vibration can cause a metal cable to swing in a magnetic field and result in an extra, induced current in the cable (Electromagnetic effects). This can distort the amplitude and phase of original sound signals in the cable and degrade the sound quality significantly.

Another source of unwanted noise comes from ground vibration. Many so-called cable elevators were designed to reduce the effects of vibration from the ground. A prior art system, as shown in FIG. 1, used a porcelain cable elevator that has a Y-shaped top support and a wide base 6. This is roughly 8˜11 cm in height. This type of cable elevator can only support a very small portion of a cable due to its fixed height. This can limit the total length of the cable to be supported. It is also difficult to be stored or shipped due to its size and weight. It cannot fine tune the sound since the material is fixed and is vulnerable to ground vibration due to the large base contact area.

In another prior art system, as shown in FIG. 2, an acrylic cable elevator is used. This has an up-side-down V shape 7 and top opening 8, and is roughly 8˜12 cm in height. This type of cable elevator can only support a very small portion of the whole cable due to its fixed height and is difficult to store and ship, as it cannot be dissembled. Also, it cannot fine tune the sound since the material is fixed and is vulnerable to ground vibration due to the large base contact area.

For the vibration induced by audio equipment, such as a CD player, feet or cones under the equipment have been used. However, some vibration can still be transferred into the connecting cable.

To reduce or eliminate the problems described above, the present invention introduces a device that has
(1) Only three or four sharp ground contacts to reduce the effects of ground vibration;
(2) Adjustable and multilayer horizontal supporting pieces to accommodate multiple cables;
(3) Various height of the vertical pieces to provide stability to a cable and also allow a longer cable to be properly supported; and
(4) Ease to be dissembled, transported, and stored.

### SUMMARY OF THE INVENTION

The first special function of the present invention is to reduce the effects of an electromagnetic field to a metal cable. As a metal conductor moving in a magnetic field, it can induce current in the metal conductor. The magnitude of the induced current is proportional to the level of the magnetic passing in a given time. Conversely, running current through a metal conductor can also induce a magnetic field and affect another metal object close to the metal conductor. Therefore, for a metal audio cable, any vibration transferred from the nearby audio equipments or ground can cause the cable to swing in a magnetic field and result in an extra, induced current in the cable. This can distort the amplitude and phase of original sound signals in the cable and degrade the sound quality significantly.

In accordance with one aspect of the present invention, an adjustable audio cable vibration reducing device comprises two porous vertical pieces that are 10˜90 cm in length and at least one horizontal supporting piece. To support the audio cables at different heights, a consumer can choose the porous vertical pieces at the most appropriate length and adjust the assembling height of horizontal supporting pieces. Therefore, the present invention can substantially stabilize a cable and increase the total length of a cable being supported. The stability of the cable can effectively reduce the induced current in the cable from the nearby electromagnetic field and retain the sound quality transmitted through the cable.

In accordance with another aspect of the present invention, there is provided an adjustable audio cable vibration reducing device comprising two porous vertical pieces that are 10˜90 cm in length and at least one horizontal supporting piece. Unlike those previous designs that have plane, circular, or line contacts between cable support and ground, the present invention has one porous vertical piece that has only two sharp contacts between the porous vertical piece and ground, and has the other porous vertical piece that has only one or two sharp contacts between the porous vertical piece and ground. The sharp contacts will not only reduce the vibration being transferred into the system by minimizing the contact area between the porous vertical piece and ground, but also accelerate the efficiency to transfer out the system existing vibration by maximizing the contact pressure between the porous vertical piece and ground. Additionally, the energy-transforming hole 15 on each vertical piece, as shown in FIG. 3, 4, 5, and 6, can be filled with a form material that can work as a damper to further reduce the vibration in the piece. The porous vertical piece can also be designed to further provide a decorative effect to the device.

In accordance with yet another aspect of the present invention, there is provided an adjustable audio cable vibration reducing device comprising two porous vertical pieces that are 10˜90 cm in length; and at least one horizontal supporting piece. The device can also accommodate multiple horizontal supporting pieces at different elevations, providing supports to multiple cables simultaneously without significant interference. This can not only well arrange the cables but also save space and cost.

In accordance with yet another aspect of the present invention, there is provided an adjustable audio cable vibration reducing device comprising two porous vertical pieces that are 10˜90 cm in length; and at least one horizontal supporting piece. By using various materials, such as acrylics, graphite, wood, porcelain, and metal, for the horizontal supporting pieces and/or vertical pieces, one can fine tune the sound to achieve certain sound preference.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

FIG. 1 is a perspective view of a porcelain cable elevator of the prior art system;

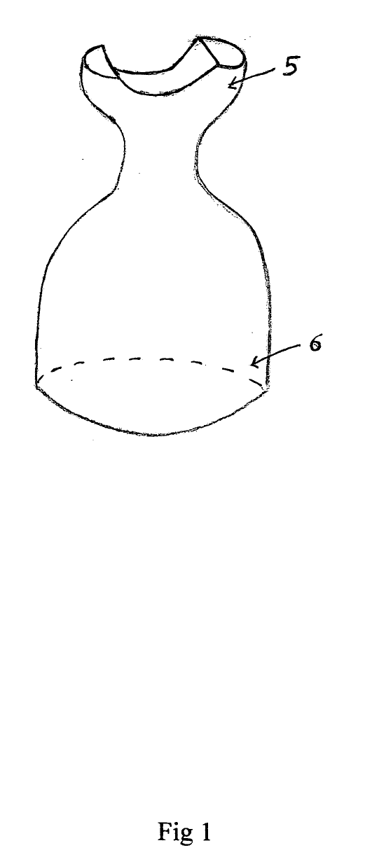

FIG. 2 is a perspective view of a acrylic cable elevator of the prior art system;

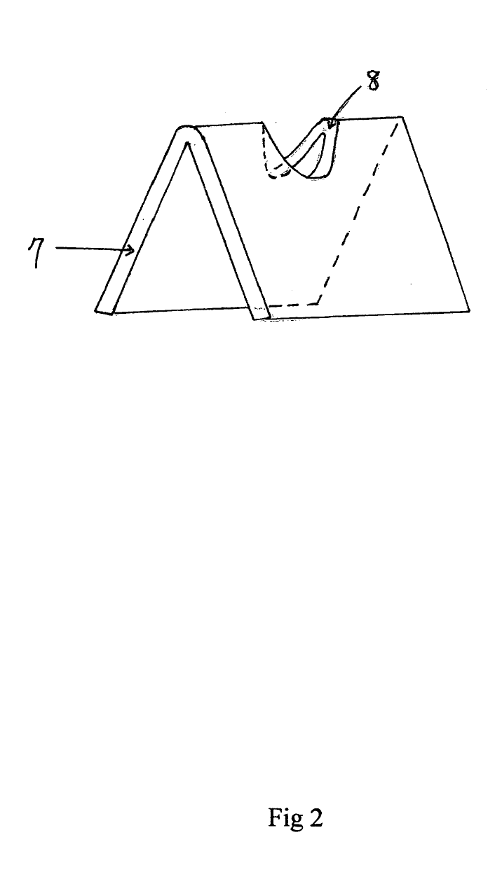

FIG. 3 is a perspective view of a preferred embodiment of the present invention;

FIG. 4 is a front, cross-sectional view of the preferred embodiment of the present invention of FIG. 3;

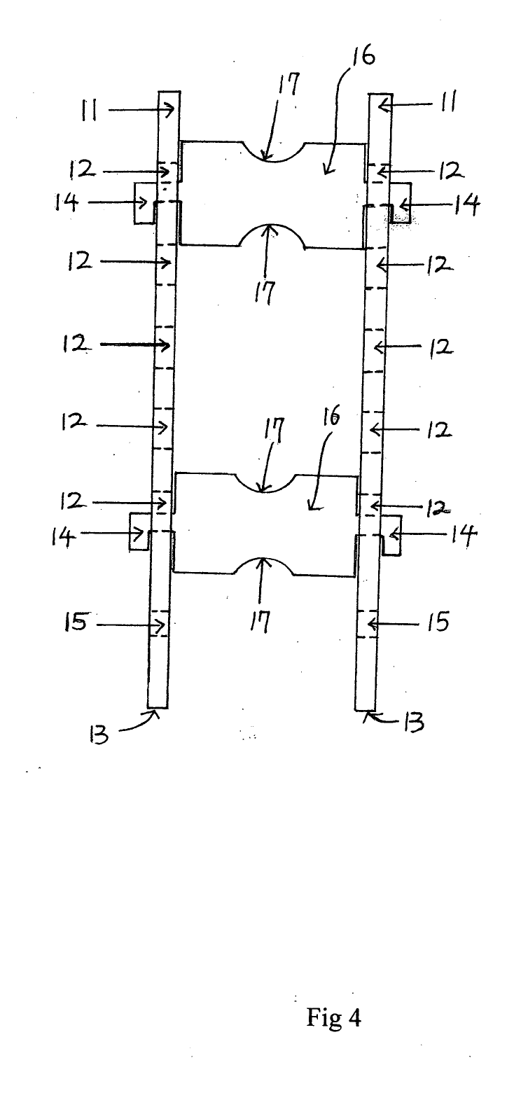

FIG. 5 is a plan view of a porous vertical piece which can be used in a preferred embodiment of the present invention;

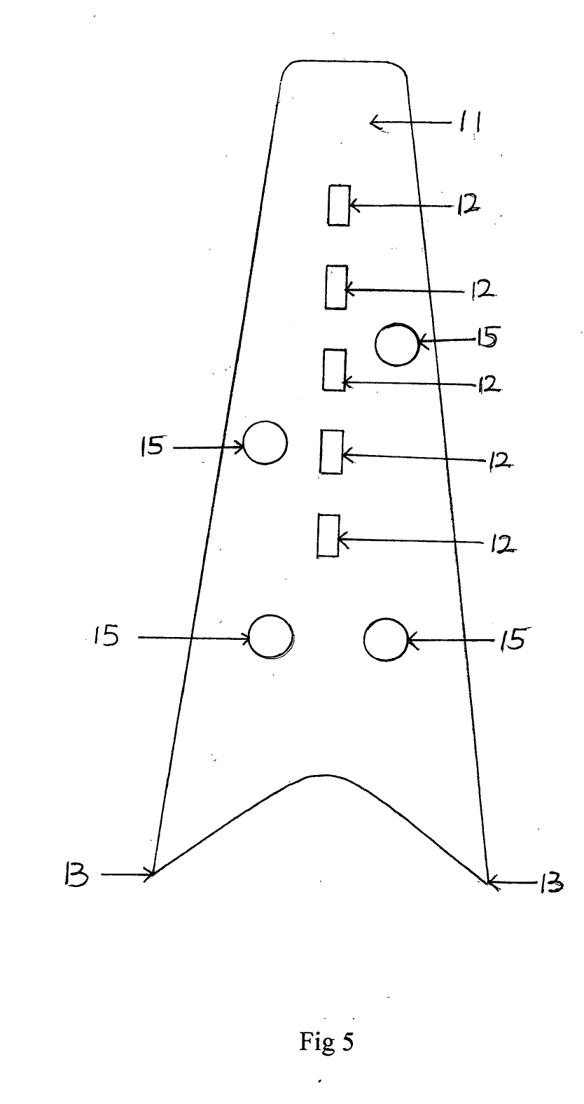

FIG. 6 is a plan view of another porous vertical piece which can be used in a preferred embodiment of the present invention;

FIG. 7 is a plan view of yet another porous vertical piece which can be used in a preferred embodiment of the present invention;

FIG. 8 is a plan view of a horizontal supporting piece which can be used in a preferred embodiment of the present invention;

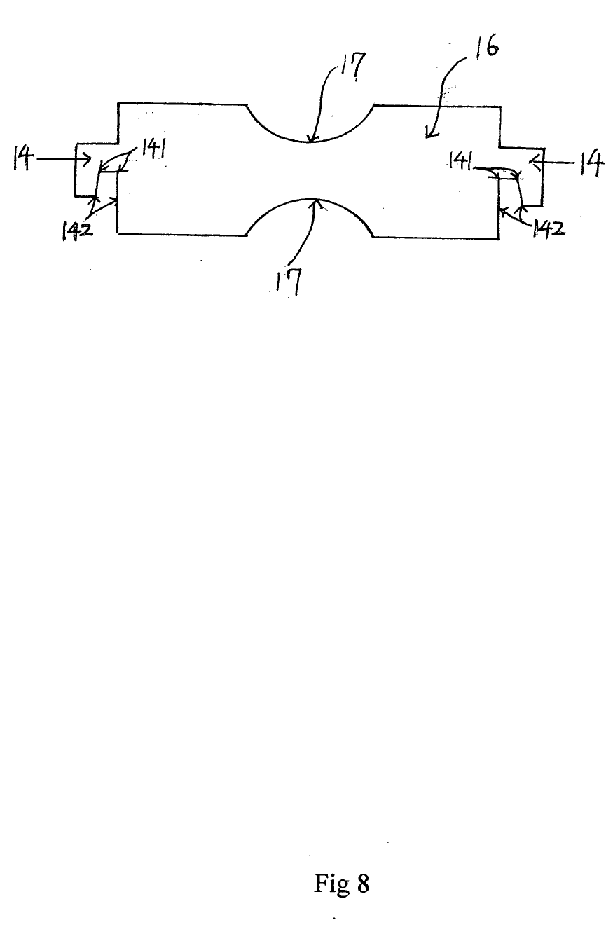

FIG. 9 illustrates an exemplary system that practices the present invention;

### DETAILED DESCRIPTION OF THE PREFERED EXEMPLARY EMBODIMENT

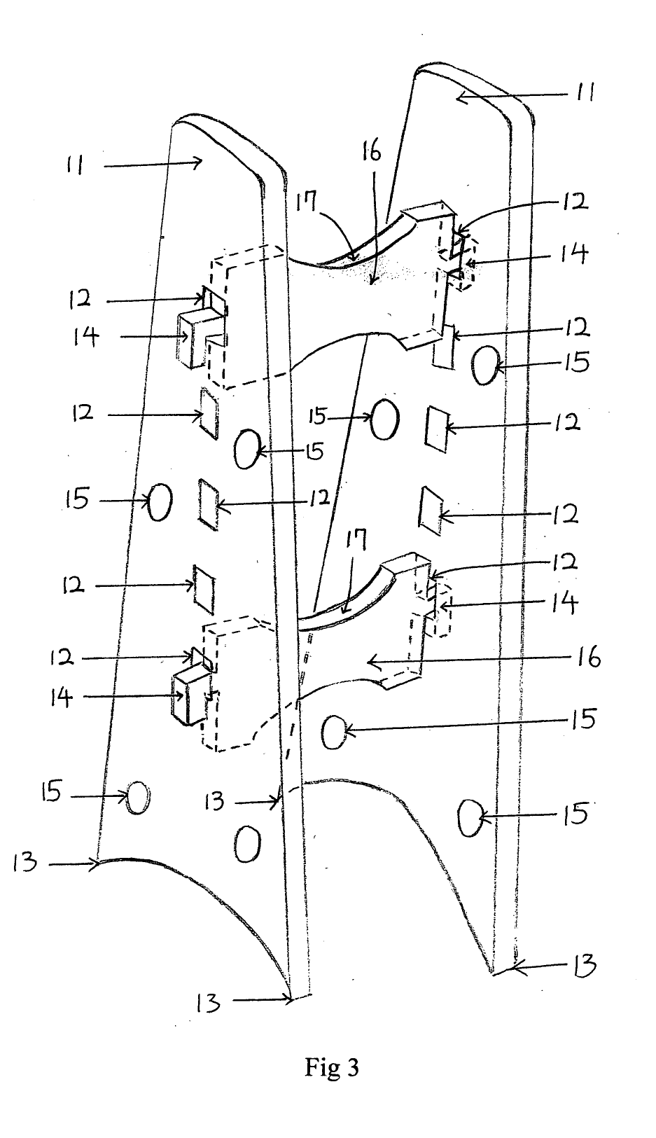

FIG. 3, 4, 5, & 8 depict a preferred embodiment of an adjustable audio cable vibration reducing device. This adjustable audio cable vibration reducing device comprises two porous vertical pieces 11, and at least one horizontal supporting piece 16.

The adjustable audio cable vibration reducing devices allow the customer to assemble or disassemble them quickly and easily by hands. On the porous vertical pieces 11, there are a few fastening holes 12. The consumer can finish assembling the adjustable audio cable vibration reducing device by inserting an L shape fastening unit 14, which is on the horizontal supporting piece 16, into the fastening hole 12 first, and then pushing the L shape fastening unit 14 down. Vice versa, the consumer can also finish disassembling the audio cable support and vibration reducing device by pushing the L shape fastening unit 14 up first, and then pulling the L shape fastening unit 14 out of the fastening hole 12.

The adjustable audio cable vibration reducing device in which the invention is embodied allows the customer to flexibly choose the appropriate length of the porous vertical pieces 11 to support cables at different heights. The length of porous vertical pieces 11 is between 10 cm˜90 cm. If the consumer wants to support the audio speaker cables, he may choose porous vertical pieces 11 in the length between 10 cm and 30 cm. However, if the consumer wants to support the audio interconnect or power cables, based on the site space restriction and height requirement of cable support, the consumer may choose porous vertical pieces 11 in the length between 10 cm and 90 cm.

In a preferred embodiment, the porous vertical piece 11 has two sharp ground contacts 13. Therefore, unlike those plane, circle or line contacts in the prior art devices, the present invented adjustable audio cable vibration reducing device may have just four sharp ground contacts 13. Assuming the ground vibrate uniformly, there will be only very few paths left to let the ground vibration transported in when there are only four sharp ground contacts 13. Besides, for the same carrying weight, if the base contact is less, the contact pressure will be bigger. Bigger contact pressure will accelerate the cable existing vibration to be dissipated into the ground. Therefore, the adjustable audio cable vibration reducing device can reduce the ground vibration transported into the cable, but accelerate to dissipate the cable existing vibration into the ground.

The porous vertical piece 11 may also have some energy-transforming holes 15. The energy-transforming holes 15 are filled with some foam and rubber materials that can transform the vibration energy into heat energy.

On the center part of the horizontal supporting piece 16, there are half circle concavities 17 that can be used to keep the supported audio cable near the center of gravity. Therefore, the overall stability will be increased when the vibrations occur.

By using the L shape fastening unit 14, consumers can finish assembling and dissembling the horizontal supporting piece 16 and the porous vertical piece 11 in just a few seconds. Therefore, consumers can not only quickly and easily adjust the cables support height to increase the total length of cables support and vibration reducing, but also easily storage and ship the device. The L shape fastening unit 14 has a top narrow opening 141, and a bottom wide opening 142. The top narrow opening 141 is narrower than the thickness of the porous vertical piece 11, but the bottom wide opening 142 is wider than the thickness of the porous vertical piece 11. Therefore, a consumer can assemble the vibration reducing device by inserting L shape fastening unit 14 into the fastening hole 12 first, and then pushing the L shape fastening unit 14 down.

Various materials, such as acrylics, graphite, wood, porcelain, and metal can be used to produce porous vertical piece 11 and/or the horizontal supporting pieces 16. Since different materials have different elastic resistance, a consumer can fine tune the sound by changing the material of the porous vertical piece 11 and the horizontal supporting pieces 16.

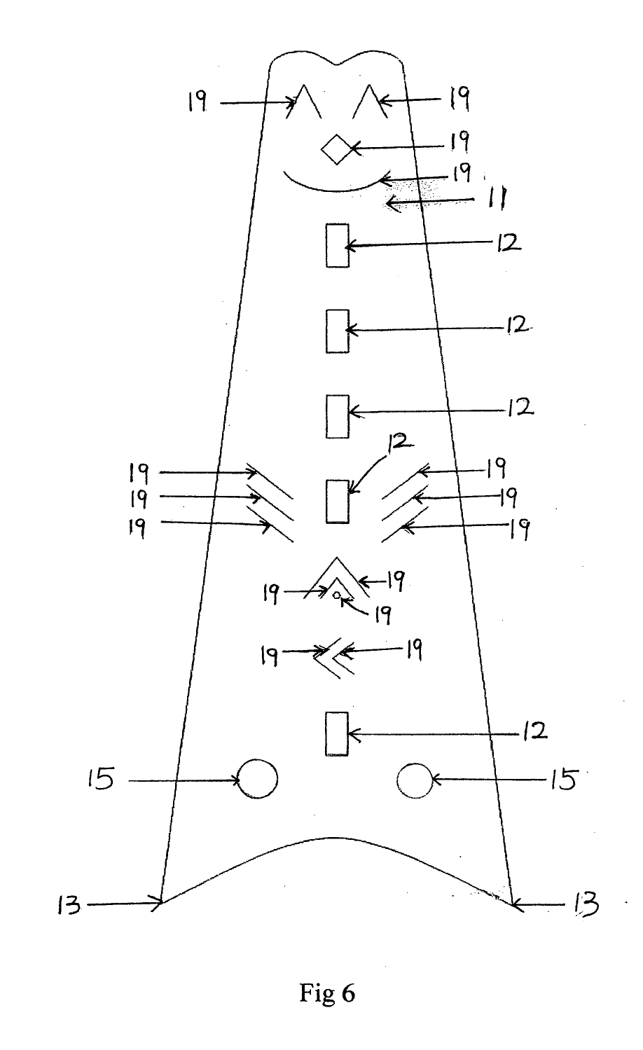

FIG. 6 depicts another example of the porous vertical piece 11. This can be designed to have decorative a pattern, for example the decorative pattern 19 shown in FIG. 6.

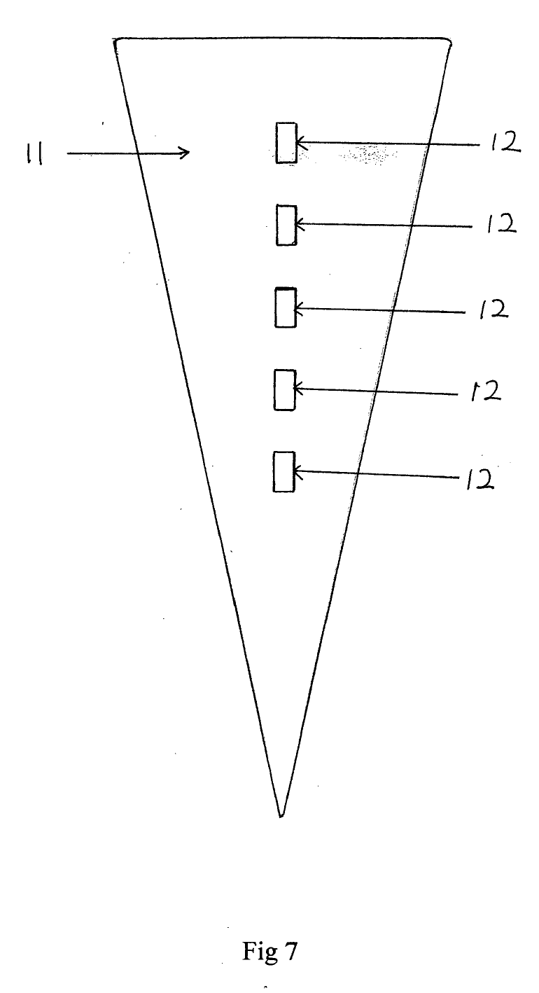

FIG. 7 depicts another example of the porous vertical piece 11. This has one sharp ground contact. Since the other porous vertical piece 11 keeps the original two sharp ground contacts, in this case, the cable vibration reducing device has only three sharp ground contacts 13. Similar to the advantages described above for the total four sharp ground contacts, the cable vibration reducing device can reduce the ground vibration transported into the cable, but accelerate to dissipate the cable existing vibration into the ground.

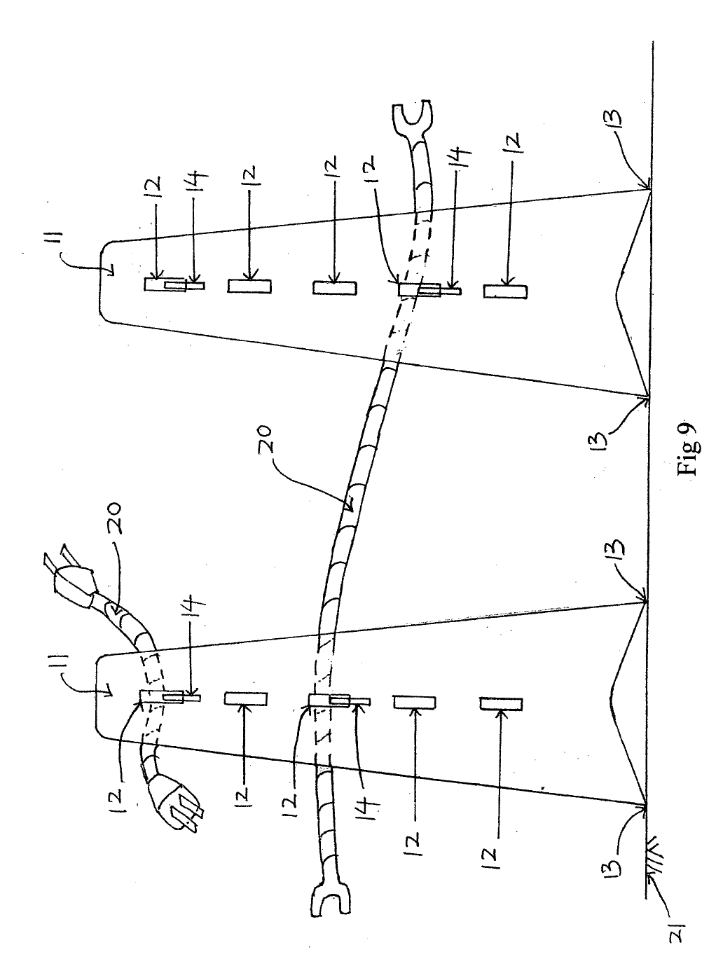

FIG. 9 illustrates an exemplary system that practices the present invention. With all kinds of audio cable 20 displaced in three dimension space, a consumer can use the adjustable audio cable vibration reducing devices of the present invention simultaneously to form a three dimension audio cable vibration reducing or support net.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

### THE MAIN ITEMS AND NUMBERINGS

5 Y-shaped top support
6 Wide base
7 Up-side-down V shape
8 Top opening
11 Porous vertical piece
12 Fastening hole
13 Sharp ground contact
14 L shape fastening unit
15 Energy-transforming hole
16 Horizontal supporting piece
17 Half circle concavity
19 Decorative pattern
20 Audio cable
21 Ground
141 Top narrow opening
142 Bottom wide opening

1. An adjustable audio cable vibration reducing device comprises two porous vertical pieces and at least one horizontal supporting piece.

2. An adjustable audio cable vibration reducing device as claimed in claim 1 wherein one of the two porous vertical pieces has two sharp ground contacts, and the other has one or two sharp ground contact.

3. An adjustable audio cable vibration reducing device as claimed in claim 1 or claim 2 wherein said the two porous vertical pieces are 10 cm˜90 cm in length.

4. An adjustable audio cable vibration reducing device in any of the proceeding claims wherein said the two porous vertical pieces have one or more energy-transforming filled with a materials for dissipating the vibrations.

5. An adjustable audio cable vibration reducing device as claimed in claim 4 wherein the material for dissipating vibrations is operable to transform vibrational energy into heat.

6. An adjustable audio cable vibration reducing device as claimed in claim 4 or claim 5 wherein the material for dissipating vibrations is a foam and/or rubber

7. An adjustable audio cable vibration reducing device as claimed in any of the preceding claims wherein on a centre part of the horizontal supporting piece there is provided one or more half circle concavities.

8. An adjustable audio cable vibration reducing device as claimed in any of the preceding claims wherein said the horizontal supporting piece has an L shape fastening unit.

9. An adjustable audio cable vibration reducing device as claimed in claim 8 wherein the L-shaped fastening unit has top narrow opening and bottom wide opening on the both ends piece.

10. An adjustable audio cable vibration reducing device as claimed in any of the preceding claims wherein the horizontal supporting piece is adjustable in height.

11. An adjustable audio cable vibration reducing device as claimed in any of the preceding claims having multiple horizontal supporting pieces at different elevations.

12. An adjustable audio cable vibration reducing device as claimed in any of the preceding claims wherein one of the two porous vertical pieces and/or at least one horizontal supporting piece are made of different materials.

13. An adjustable audio cable vibration reducing device as claimed in claim 12 wherein the materials are any one or more of an acrylic, graphite, wood, porcelain, and metal.
